(19) United States
(12) Patent Application Publication
(10) Pub. No.: US 2012/0216371 A1
(43) Pub. Date: Aug. 30, 2012

(54) HINGE

(75) Inventor: Johannes Schneider, Michelau (DE)

(73) Assignee: DR. SCHNEIDER KUNSTSTOFFWERKE GMBH, Kronach (DE)

(21) Appl. No.: 13/504,345

(22) PCT Filed: Dec. 3, 2010
(86) PCT No.: PCT/EP2010/068818

§ 371 Date: Apr. 26, 2012

(30) Foreign Application Priority Data
Dec. 14, 2009 (DE) 20 2009 015 725.3

(51) Int. Cl. E05D 1/06; H01F 7/00; E05D 11/08; E05D 11/10

(52) U.S. Cl. 16/268

(57) ABSTRACT

The present invention relates to a hinge for pivotable connection of two components (1, 2), consisting of at least one first round hinge element (3, 4) at the first component (1) and at least one corresponding second round hinge element (5, 6) at the second component (2), which hinge elements (3, 5; 4, 6) are connected together to be rotatable about the centre axis. The first hinge element (3, 4) is a bearing sleeve (7, 8) with a longitudinal gap, by way of which an insertion sleeve (11, 12), similarly provided with a longitudinal gap (13, 14), as second hinge element (5, 6) can be rotated into place in its entirety.

The invention relates to a hinge for pivotable connection of two components consisting of at least one first round hinge element at the first component and at least one corresponding second round hinge element at the second component, which hinge elements are connected together to be rotatable about the centre axis.

Hinges movably connect two planes at an edge. They are designed as a connecting joint in order to connect together two components. For example, hinges are used at doors or rids of containers for opening and closing the respective space, which is covered. There are hinges which in terms of weight can be subjected to high loading and have correspondingly strongly constructed strips and pins connecting the rotary joints together. In addition, use is made—particularly for connecting lightweight components—of hinges of plastics material, which are light, able to be produced economically in large batch numbers and can be built up in simple manner or are injection-moulded at plastics material parts, which are to be connected, as film hinges therebetween. Such hinges essentially consist of a thin-walled connection, often in the form of a fold, which through its flexibility enables limited rotational movement of the connected components. Polypropylene is preferably used as the material due to a marked resistance to wear. Film hinges have a limited capability of loading and a low shear strength. The hinge ends lead, in frequent use, to breakage or tearing.

Increasingly, however, use is also made of other hinges which are composed of plastics material and consists, in classic form, of rotary joints which are injection-moulded at the components or lateral strips and are insertable one into the other in comb-like manner and connected together by means of a pin. The pin can similarly consist of plastics material. Such plastics material hinges of classic mode of construction can replace hinges made of sheet steel.

The known hinges basically make it necessary for the hinge parts to be connected together by a pin which has to be secured in the hole row. This takes place, for example, by a screw or by forming a second head on the pin, so that slipping through to either side is avoided. They are screw-connected in preassembled state to the components, which are to be connected together, by way of the strap-shaped components which are provided as strips. This requires skilful dexterity. If the two hinge halves are mounted on components beforehand and then inserted one into the other in order to be able to connected by a pin, a precise preassembly of the two hinge halves at the respective components is required.

If the hinge halves at the same time serve the purpose of connecting together two plastics material parts, then the separate production and separate mounting of such a hinge represents a high level of assembly effort. Since, for example, a small container, which is closed by a lid pivotably fastened thereto by way of a hinge, is relatively cheap, the hinge of plastics material of known mode of construction is relatively expensive. Replacement by a film hinge is usually not feasible if the lid is to be frequently used, such as, for example, in the case of a cover of a storage compartment in a motor vehicle. Moreover, braking moments in the known hinges are not preset. It is accordingly known to separately insert braking means in such hinges into order to produce defined levels of friction so as to achieve desired slide properties or braking characteristics during actuation of the hinges. For example, it can be achieved by this means that the cover can be kept open in different inclined settings.

Starting from the known prior art the invention has the object of so constructing a hinge of the kind according to category that the two hinge elements can be easily mounted at the components to be connected and that they can be joined radially one in the other without use of a pin and through material selection or by constructional design are suitable for exerting a defined braking moment. A further object consists in limiting the pivot travel of the hinge.

The invention fulfils the task by construction of the hinge in accordance with the teaching indicated in claim 1.

Each individual hinge accordingly consists of a first hinge element, which forms a bearing sleeve having a longitudinal gap. This hinge element is fastened to or formed on the first component to protrude at a longitudinal side in such a manner that the bearing sleeve in practice protrudes beyond the edge. The longitudinal gap which separates the bearing sleeve and has a defined width is in that case disposed in the region of the circumferential wall of the bearing sleeve opposite the fastening to the component. The position does not have to be exactly opposite and the longitudinal gap can also be provided to extend at an angle to the plane of the component. The clear width of the longitudinal gap should stand in a specific ratio to the outer diameter, the total length and the wall thickness. An insertion sleeve, similarly provided with a longitudinal gap, is mounted at the second component as second hinge element. The insertion sleeve is so fastened by at least one end face to the second component that the circumferential surface of the insertion sleeve is circumferentially free. The longitudinal gap of the insertion sleeve is arranged to be freely accessible for insertion into the longitudinal gap of the bearing sleeve. In addition, the outer diameter of the insertion sleeve is matched to the inner diameter of the bearing sleeve. The outer diameter is smaller, for example by twice the wall thickness of the bearing sleeve if the wall thicknesses of the two sleeves are selected to be of the same size. In every case the outer diameter of the insertion sleeve should be so dimensioned that with consideration of the resilient design of the circumferential wall the insertion sleeve introduced into the bearing sleeve can rotate.

At least the insertion sleeve has at least one sleeve wall section which extends at one side of the longitudinal gap and is of resilient construction. Here, too, the width of the longitudinal gap is dimensioned in correspondence with a specific relationship to the outer diameter, the overall length and the wall thickness, so that introduction of the longitudinal gap of the insertion sleeve into the longitudinal gap of the bearing sleeve and a subsequent rotation into place is possible. Through simultaneous relative rotation of the components with respect to one another the insertion sleeve is completely rotated into the bearing sleeve, wherein the lateral circumferential wall sections of the insertion sleeve are, with utilisation of intrinsic resilience or the resilience of the circumferential wall of the bearing sleeve, slightly turned towards one another during the rotation into place, and when the circumferential wall of the insertion sleeve is completely drawn into the bearing sleeve bears against the inner wall of the bearing sleeve. In that regard, the friction between the two hinge elements is determined in correspondence with the selected inner diameter of the bearing sleeve and the outer diameter of the insertion sleeve or the design of a resilient limb in the circumferential wall of the bearing sleeve. This friction is, however, also presettable in variable manner, for example the tube-spring stress can be designed to be variable and thermostable by means of an additional element of metal which is inserted into the insertion sleeve and which has a defined spreading action on the insertion sleeve. By way of example, an annular C-spring is suitable as additional element.

The friction force between the two sleeves which can be joined one in the other can be defined in numerous modes and manners also at the sleeves. If, for example, a continuous circumferential wall section in the immediate vicinity of the longitudinal gap of the insertion sleeve is formed to be resilient, for example is somewhat more thinly-walled or resilient than the rest of the wall section, then this wall section produces a defined contact pressure at the inner surface of the bearing sleeve. The contact pressure can, however, also be set in that resilient tongues are provided or formed to protrude from the circumferential wall and, when the rotation one into the other takes place, resiliently bear against the inner side of the bearing sleeve circumferential wall. Equally, such sections and corresponding co-operating sections can be provided in the bearing wall. If, however, penetration of liquid into the hinge is to be avoided as far as possible, then the bearing sleeve should usually have a closed form apart from the longitudinal gap formation. The insertion sleeve can be fastened in simple manner to a wedge-shaped fixing surface of the component by way of, for example, its edge at the end face. The end face can also be formed entirely at the component. The bearing sleeve, thereagainst, is always fastened to a longitudinal edge of the first component. The bearing sleeve and also the insertion sleeve can, for example, also be bent from thin sheet metal or spring sheet metal, such as bronze sheet metal. However, the invention offers advantages particularly when the hinge elements consist of plastics material and are injection-moulded on the component directly in the injection-moulding process. No separate assembly processes, such as screw-connecting, riveting, soldering or welding, then need to be undertaken here. Moreover, if the hinge element is a constituent of the component this can then be produced with a slight increase in tool price.

In principle, the bearing sleeve and the insertion sleeve can be longitudinally slit hinge elements. In this case, it has to be ensured that, for example, a lateral displacement in the assembled state is not possible due to lateral bearing limitation of the lid at a container. The problem of lateral displacement can, however, also be solved in simple manner if at least respective paired bearing sleeves with open or closed base are arranged at the first component and correspondingly thereto at least respective paired insertion sleeves with open or closed base are arranged at the second component. If two such hinges are arranged at a spacing from one another and it is ensured that, for example, the closed or open base of the bearing sleeves is disposed at the outer side and the closed or open base of the bearing sleeves is disposed at the inner side, then it is evident that after joining the paired hinge elements one in the other a relative lateral displacement of the two components is no longer possible.

The open base can, for example, be a protruding annular flange so that, for example, a cable can also be led through the tubular hinge. This has particular advantages if the hinge, for example, connects two components in a motor vehicle which are to be movable relative to one another and a wiring loom is to be conducted via the connection. Through the central guidance of the wiring loom through the tubular hinge there is no mechanical loading of the wiring loom. In addition, it is evident that through use of a closed base no liquid can penetrate into a hinge. This would indeed in principle be possible via the longitudinal gap in the bearing sleeve, but since the longitudinal gaps in the two sleeves are offset relative to one another in such a manner that in the case of normal pivot movement the longitudinal gap in the bearing sleeve is covered by the wall section of the insertion sleeve, penetration of liquid is not possible In the case of use of particularly thin walls and materials with inherent resilience, particularly with respect to the insertion sleeves, it is also possible to mount a closed base at the circumferential wall of the insertion sleeve. With use of the resilience, rotation into place in the bearing sleeve is nevertheless possible. An insertion can be substantially facilitated in that a section of the circumferential wall is cut free longitudinally of the base so that this section is exposed as resilient section.

In the case of integrally forming or cutting free a resilient section it is also possible to provide at the section itself a detent element protruding at the outer side, a separate brake surface of a different material, or a coating. In the case of a detent element this can be, for example, a longitudinal bead which is formed integrally or, in the case of use of sheet metal, pressed in. This bead can be so arranged that for pivot travel limitation it engages against an edge of the longitudinal gap in the bearing sleeve, wherein through flank matching a further pivotation in at least one of the two rotational directions is possible or not possible. Through provision of a slide-over surface, rotation in a desired direction beyond the edge of the longitudinal gap can be made possible. However, for a detented setting it is also possible to form in the inner wall of the bearing sleeve several detent recesses into which the detent element or the detent elements at the outer side of the circumferential wall of the insertion sleeve can engage when rotation takes place. Such detent elements can also be provided at the cut-free or mounted spring elements. Through the provided detents a ratchet function is imparted by micro-detents, whereby it is possible to be able to retain one component in different detent settings relative to the other in simple manner. If, for example, such a hinge is used in connection with display screens fastened to headrests, then the detent settings of the display screens can thereby be set in simple manner at different angles of inclination with respect to the individual viewer. Obviously, such detent functions can also be provided at hinges which, for example, are used with panels and other components, where this is desired.

The advantageous forms of embodiment are indicated in detail in the subclaims.

Since the two hinge elements which interengage form cavities such a hinge is particularly suitable for a cable guide. The cable can in that case be pulled axially through a row of the hinge elements if a hinge strip is concerned, but it can also end behind each individual hinge. For the pulling through, the end wall is to be provided with a passage bore or such a wall is to be dispensed with. In such a case the components would have to be connected with the end surfaces.

Since the cavity is present in any case, use can also be made of other functional inserts, for example even a lamp or a light-emitting diode, which is arranged in a housing and which at the rear side has a cable connection which is led through the centre bore or through a continuously open hinge according to the invention. This light-emitting diode can be used for the purpose of illuminating the hinge as such. However, the light can also issue between the two adjacent hinge elements. Ambient lighting effects can thus be realised directly or also indirectly. If, for example, a hinge according to the invention is used for the panel of a mirror at a sun visor in a motor vehicle, then there can also be provided between the adjacent hinge elements a continuous light source which is inserted into the cavities of the adjacent hinge bodies in order to illuminate the mirror. In principle, hinges constructed in accordance with the invention can thus be used in conjunction with lamps where surfaces are to be illuminated when a flap is opened. In that case, the cavities of the hinges can also serve, since they are opposite one another, as accommodation for lamp bodies. Obviously, such hinges can also be used in fold-out lamps, for example reading lamps in a motor vehicle. A reflector curved about the longitudinal axis at a defined radius can also be mounted between the hinges, for example formed at the component, in order to be able to allow the light to issue in a specific direction when the hinge is pivoted.

It is often desired for hinges, insofar as they do not have detents, to have a non-physical, smooth motion, In the case of the hinge constructed in accordance with the invention this is already imparted just by the spring forces of the circumferential walls. However, in addition silicon inserts, whether in flat form or in annular form, can also be used to achieve a specific desired sliding property between the mutually adjoining surfaces. For this purpose it is also possible to form grooves in the circumferential walls, into which grooves such elements are inserted, for example also a silicon O-ring, which produces a damping frictional characteristic.

If beyond that it is desired to achieve rotational movements with defined damping, then it is possible to insert in the cavity, which is formed by the hinge elements, a brake element which co-operates with the circumferential wall. Such brake elements serve for damping the rotational movement and consist of a rotor, which, for example, is rotatably mounted in a bearing socket, wherein the motor and the bearing socket are arranged to be rotatable relative to one another. in that case either the rotor can be connected with the element and the bearing socket statically fixed to a housing or to a mount or the bearing socket together with the element and the rotor can be fixed in stationary position to a housing or a mount of the hinge. The housing is formed by the circumferential walls of the bearing sleeve or the insertion sleeve. The at least individually provided brake device in that case exerts a braking force on the circumferential walls. The rotor can then bear by spring action or magnetic effect. Examples thereof are described in DE 103 52 445 B4, DE 100 61 030 B4, DE 203 18 076 U1, DE 20 2004 016 117 U1 and DE 203 05 291 U1. All brake elements disclosed there are, with appropriate dimensional design, insertable into the cavities of the hinges according to the invention. Obviously, use can also be made of commercially available silicon brakes in order to achieve a desired braking effect. Through the circumferential surfaces, which in the case of hinges according to the invention rub against one another, it is also possible to impress lubricant grooves into these or, if they consist of plastics material, to conjunctively form such grooves, into which a lubricant is then added or into which also a silicon can be injected in order to lastingly achieve the desired movement damping on relative rotation of the components with respect to one another.

The invention is explained further in the following by way of the embodiments illustrated in the drawings, in which:

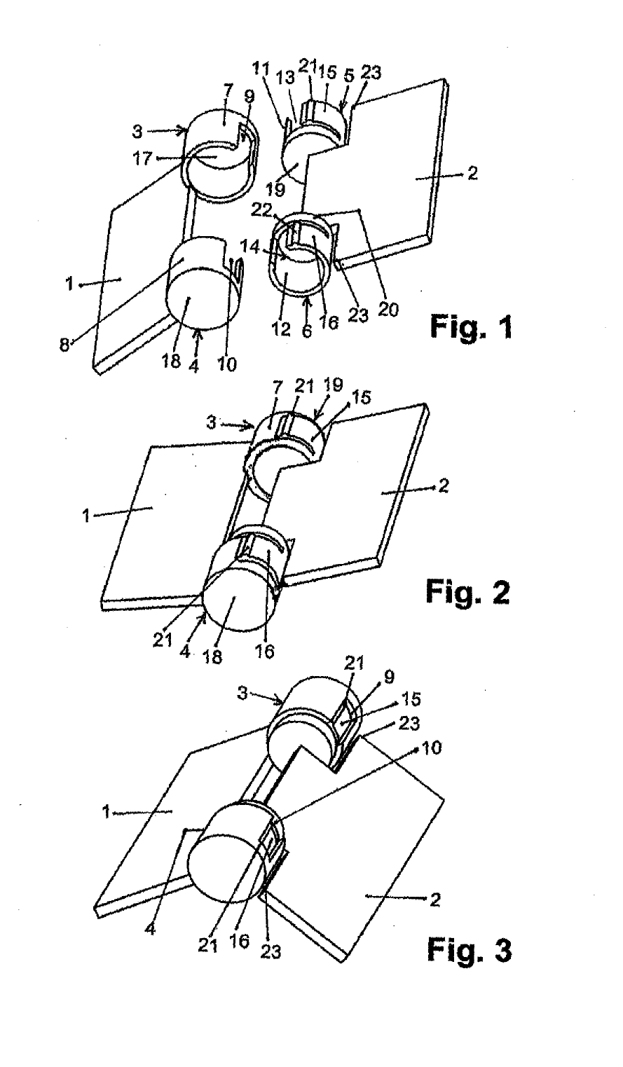

FIG. 1 shows, in an exploded illustration, two components with hinge elements according to the invention,

FIG. 2 shows the partly rotated-together hinge elements according to FIG. 1,

FIG. 3 shows the hinge elements according to FIG. 1 rotated one into the other,

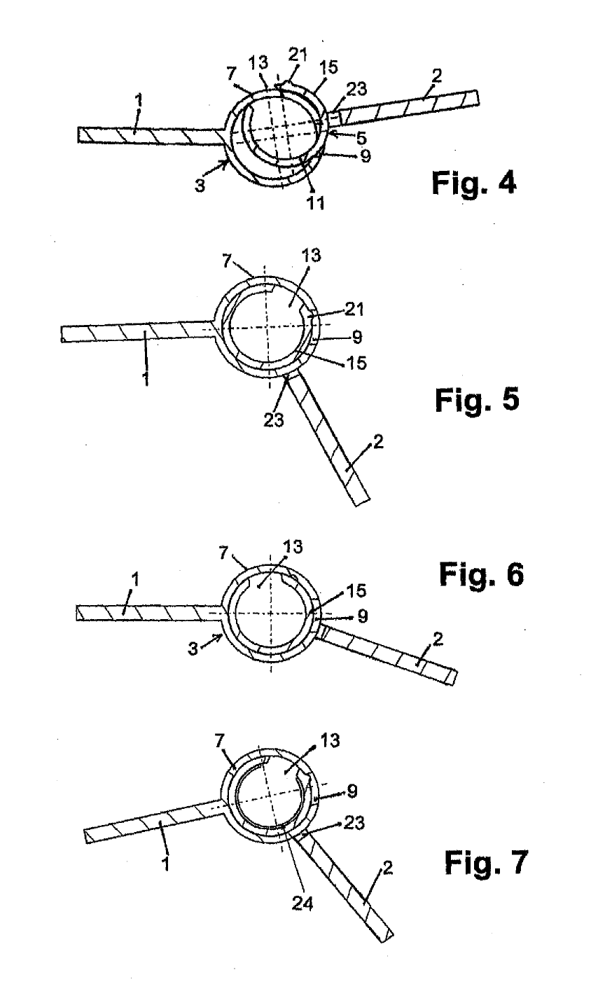

FIG. 4 shows, in a sectional side view, the hinge elements after introduction of the insertion sleeve into the longitudinal slot of the bearing sleeve,

FIG. 5 shows two sleeves, which are rotated one into the other, in a detent setting,

FIG. 6 shows the sleeves, which are rotated one into the other, in a clamping setting,

FIG. 7 shows sleeves, which are inserted one into the other, with inserted C-ring,

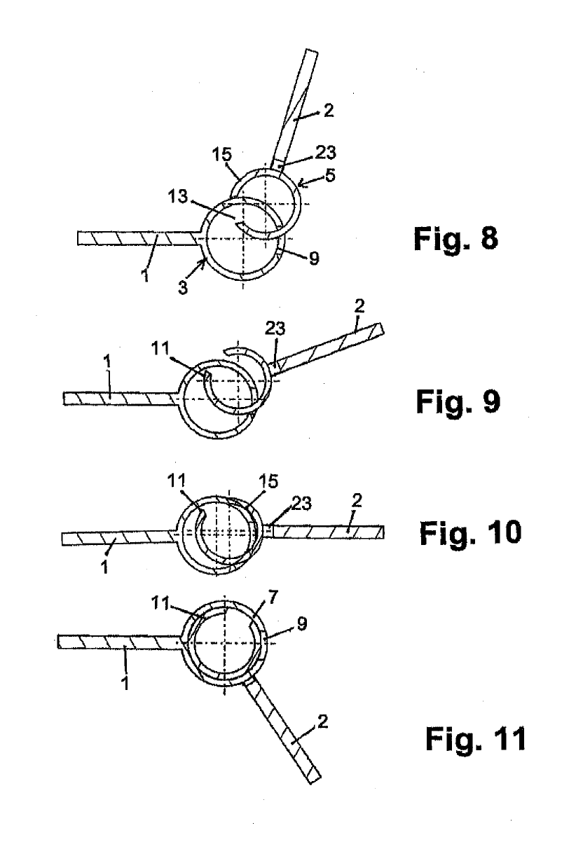

FIG. 8 shows, in sectional side view, two hinge elements, the insertion sleeve of which is introduced into the bearing sleeve via longitudinal gaps, wherein the insertion sleeve does not have a detent projection,

FIG. 9 shows a hinge element according to FIG. 8 in a first rotational setting,

FIG. 10 shows the hinge elements according to FIG. 8 in a further rotational setting and

FIG. 11 shows the hinge elements in a rotational setting in which the two sleeves are rotatably mounted to engage one in the other.

All figures show a first component 1 of plastics material with integrally formed hinge elements 3, 4, which each consist of a bearing sleeve 7, 8 with respective closed bases 17, 18, the bases being mounted at the opposite ends, and which are provided with longitudinal gaps 9, 10 extending up to the bases. The longitudinal gaps 9, 10 are provided at the first component 1 approximately opposite the fastening sides of the first hinge elements 3, 4. The component is a plastics material moulded part which is produced in an injection-moulding method and at which the hinge elements 3, 4 are integrally formed. Provided congruently in correspondence with these bearing sleeves 7, 8 at a second component 2 are second hinge elements 5, 6 which are constructed as insertion sleeves 11, 12 and which each have a closed base 19 or 20, which sleeves are so attached opposite to one another to the second component 2 that a guide slot 23 is formed between the circumferential wall and the second component 2. This guide slot 23 can be formed to be longer than the insertion sleeve 5, 6. In addition, the component 2 can in this region be only a spacer part which corresponds with the spacing between the two bases 19, 20.

The insertion sleeves 11, 12 are radially fastened to the second component 2 at the base side and extend outwardly by the open sleeve wall. Longitudinal gaps 13, 14, which have a defined clear width, are similarly formed in the insertion sleeves. Moreover, the two sleeve sections 15, 16 on the righthand side are cut free relative to the base 19, 20, so that these sections are, with exploitation of the intrinsic elasticity, resilient. Two bead-shaped detent elements 21, 22 are formed at these sections in the region near the gap.

It will be evident that the insertion sleeves 11, 12 of the second hinge elements 5, 6 are insertable by the longitudinal gaps 13, 14 thereof into the longitudinal gaps 9, 10 of the bearing sleeves 7, 8 of the first hinge elements 3, 4 in a specific relative angular setting of the components 1, 2. They can then be rotated relative to one another, which is apparent from FIG. 2. In that case the circumferential walls 7, 8 enter the guide slots 23 and the resilient sleeve wall sections 15, 16 enter the interior space of the bearing sleeves 7, 8. Through further relative pivotation and with utilisation of the resilience of the sleeve wall sections 15, 16 as well as the resilience of the remaining circumferential wall sections of the sleeves it is achieved that the first hinge elements 3, 4 and the second hinge elements 5, 6 are rotated one into the other, which is evident from FIG. 3. The hinge can in this mode and manner be produced from the two plastics material moulded parts. In that case, the detent elements 21, 22 enter, for example, the longitudinal gaps 9, 10 and bear, as apparent from FIG. 3, against one edge. If the two components 1, 2 are pivoted relative to one another, they can also slide over the edges of the longitudinal gaps 9, 10 and bear, under a defined stress, against the inner surface of the circumferential wall of the bearing sleeves 7, 8. The described assembly steps are illustrated in FIGS. 5 and 6. A special feature is illustrated in FIG. 7. Through the hinge elements slidingly guided together one in the other there is created between the sleeves a tube-spring stress which can be designed to be variable and thermostable through the C-spring inserted into the insertion sleeve.

In FIGS. 8, 9, 10 and lithe sleeves without detent elements are illustrated in the assembly steps. Moreover, these figures shall demonstrate that even when a closed base is present at each of the bearing sleeves 7, 8 and the insertion sleeves 11, 12, insertion of the two sleeves one into the other is possible if the wall thicknesses and the material used permit a resilience which enables slight deformation of the end sections of the circumferential wall in the region of the longitudinal gaps during rotation of one into the other, but maintain their shape when the two sleeves have been rotated one into the other.

A hinge according to the invention can be used in many ways. The applications are, particularly, rotationally or pivotably mounted folding cover closures with high demands on strength, as in the case of covers of compartments in the field of automobile interiors in conjunction with pivotable parts in the automobile itself, in the toys industry in the case of toys, and in the field of domestic products. The range of use is unlimited. Depending on the respective design form and materials used, such hinges can, for example, also be employed as window hinges.

### REFERENCE NUMERAL LIST

1 first component
2 second component
3 first hinge element
4 first hinge element
5 second hinge element
6 second hinge element
7 bearing sleeve
8 bearing sleeve
9 longitudinal gap
10 longitudinal gap
11 insertion sleeve
12 insertion sleeve
13 longitudinal gap
14 longitudinal gap
15 sleeve wall section
16 sleeve wall section
17 closed base
18 closed base
19 closed base
20 closed base
21 detent element
22 detent element
23 guide slot
24 C-ring-spring

1-16. (canceled)

17. Hinge with two pivotably connected components (1, 2) and with at least one first round hinge element (3, 4) at the first component (1) and at least one corresponding second round hinge element (5, 6) at the second component (2), which hinge elements (3, 5; 4, 6) are connected together to be rotatable about the centre axis, wherein:
the first hinge element (3, 4) is a bearing sleeve (7, 8) with a longitudinal gap (9, 10),
an insertion sleeve (11, 12) with a longitudinal gap (13, 14) is fastened to the second component (2) as second hinge, element (5, 6),
the outer diameter of the insertion sleeve (11, 12) is so matched to the inner diameter of the bearing sleeve (7, 8) and the outer diameter of the insertion sleeve (11, 12) is so dimensioned that with consideration of the resilient design of the circumferential wall the insertion sleeve (11, 12) can rotate in the bearing sleeve (7, 8),
at least one sleeve wall section (15, 16) at the longitudinal gap (13, 14) of the insertion sleeve (11, 12) is formed to be resilient and
the insertion sleeve (11, 12) is insertable by the longitudinal gap (13, 14) into the longitudinal gap (9, 10) of the bearing sleeve (7, 8) and through relative rotation of the components (1, 2) can be rotated completely into the bearing sleeve (7, 8),
wherein
the bearing sleeve of the first hinge element (3, 4) is fastened to or formed on the first component (1) to protrude at the longitudinal side in such a manner that the longitudinal gap (9, 10) is disposed in the region of the circumferential wall of the bearing sleeve (7, 8) opposite the fastening,
the bearing sleeve (11, 12) fastened to the second component (2) is fastened at at least one end face in such a manner that the circumferential surface of the insertion sleeve (11, 12) is circumferentially free and the longitudinal gap (13, 14) of the insertion sleeve (11, 12) is freely accessible for insertion into the longitudinal gap (9, 10) in the bearing sleeve (7, 8) and
the said resilient sleeve wall section (15, 16) is a cut-free resilient sleeve wall section (15, 16), which adjoins the longitudinal gap (9, 10).

18. Hinge according to claim 17, wherein at least respective paired bearing sleeves (7, 8) with open or closed base (17, 18) are arranged at the first component (1) and correspondingly thereto at least respective insertion sleeves (11, 12) in paired arrangement with open or closed base (19, 20) are arranged at the second component (2).

19. Hinge according to claim 17, wherein the insertion sleeves (11, 12) and/or the bearing sleeves (7, 8) are of cylindrical form and each have at an end face a base (17, 18; 19, 20) or an annular flange covering the end face of the respective other sleeve, wherein two bases (17, 19; 18, 20) or the annular flanges are arranged oppositely at the outer side referred to a pair of hinge elements (3, 5; 4, 6) rotatable one into the other.

20. Hinge according to claim 17, wherein the sleeve circumferential wall of the insertion sleeve (11, 12) and/or bearing sleeve (7, 8) is of resilient construction.

21. Hinge according to claim 17, wherein the insertion sleeve (11, 12) has at the sleeve circumferential wall or at the sleeve wall section (15, 16) at least one detent element (21, 22) protruding at the outer side, brake surface or brake element.

22. Hinge according to claim 21, wherein the bearing sleeve (7, 8) has at the inner side at the sleeve circumferential wall at least one detent receptacle for the detent element (21, 22) or that the detent element (21, 22) on pivotation of the components (1, 2) has detenting engagement in the longitudinal gap (13, 14) of the bearing sleeve (7, 8).

23. Hinge according to claim 22, wherein several detent receptacles are provided in distribution over the circumference of the inner surface of the bearing sleeve (7, 8) for several detent settings.

24. Hinge according to claim 17, wherein circumferential wall of the bearing sleeve (7, 8) and/or that of the insertion sleeve (11, 12) has or have at least one tongue-shaped spring element which protrudes from the surface of the insertion sleeve (11, 12) or into the interior space of the bearing sleeve (7, 8) and that the respective mating sleeve has in the region of the spring element a stiffly resilient wall section or a non-resilient wall section.

25. Hinge according to claim 17, wherein the hinge elements (3, 4; 5, 6) consist of plastics material or metal.

26. Hinge according to claim 17, wherein the hinge elements (3, 4; 5, 6) together with the respective components (1, 2) consist of plastics material and are each of integral construction.

27. Hinge according to claim 17, wherein a spring-loaded element (24) defining the friction force between the insertion sleeve (11, 12) and the bearing sleeve (7, 8) is inserted into the insertion sleeve (11, 12).

28. Hinge according to claim 17, wherein a cable for connection of energy consumers is led in axial direction through at least one arrangement consisting of two hinge elements (3, 5; 4, 6) or a lighting element with a cable connection, which is led through a bore in one end wall, is inserted into the hinge element, or another functional insert which emits light from the open end face is inserted.

29. Hinge according to claim 17, wherein a flat or annular silicon insert is introduced between the mutually adjoining surfaces of the hinge elements (3, 5; 4, 6) or hinge grooves or grooves for reception of other slide means or brake means are formed in at least one of the circumferential surfaces of the insertion sleeve (11, 12) or the bearing sleeve (7, 8).

30. Hinge according to claim 17, wherein mechanical, electromechanical or magnetic brake elements are inserted into the cavity of the hinge elements and produce a force-dependent movement path of the thus-damped hinge.

31. Hinge according to claim 30, wherein a rotating brake element is inserted into the internal cavity of a hinge element (3, 5; 4, 6), wherein the casing of the bearing sleeve (7, 8) is extended and the stationary brake part is fixed thereon and the cylindrical brake part engages in the cavity of the insertion sleeve (11, 12) and acts directly on the sleeve inner wall.
